(19) United States
(12) Patent Application Publication
(10) Pub. No.: US 2015/0070239 A1
(43) Pub. Date: Mar. 12, 2015

(54) ANTENNA

(71) Applicant: MEDIATEK Inc., Hsin-Chu City (TW)

(72) Inventors: Kuo-Fong Hung, Changhua City (TW); Chia-Wei Chi, Taipei City (TW); Shih-Huang Yeh, Hsinchu City (TW)

(73) Assignee: MEDIATEK Inc., Hsin-Chu City (TW)

(21) Appl. No.: 14/277,085

(22) Filed: May 14, 2014

Related U.S. Application Data
(60) Provisional application No. 61/875,800, filed on Sep. 10, 2013.

(51) Int. Cl. H01Q 1/48; H01Q 9/04

(52) U.S. Cl. CPC H01Q 1/48; H01Q 9/045
USPC 343/848

(57) ABSTRACT

The invention provides an antenna for a wireless device, e.g., a cellular phone for wireless mobile telecommunication. The antenna includes a conductive feed strip and a conductive ground component. The ground component is for connecting a ground voltage, and comprises a portion along a surface of the device. The feed strip has a feed port for relaying a feed signal, and does not physically contact the ground component, so as to feed the ground component by noncontact electrical coupling, instead of physical contact.

This application claims the benefit of U.S. provisional application Ser. No. 61/875,800, filed Sep. 10, 2013, the subject matter of which is incorporated herein by reference.

### FIELD OF THE INVENTION

The present invention relates to an antenna for a wireless device, and more particularly, to an antenna feeding a ground component by noncontact electrical coupling of a feed strip, wherein the ground component includes a portion of a metal part along surface(s) of the wireless device.

### BACKGROUND OF THE INVENTION

Wireless electronic device, such as cellular phone and smart phone for wireless mobile telecommunication, as well as tablet computer, portable computer, handheld computer, digital camera, digital camcorder, media player, radio, television, networking apparatus (e.g., wireless network hub), sensor, surveillance apparatus and wearable gadgets (e.g., glasses or watch) capable of wireless interconnection, along with navigator and positioning apparatus (e.g., apparatus for satellite positioning), etc., has become popular, prevailing and essential in contemporary daily life.

For better user experience, mechanical robustness and/or functionality requirement, housing of modern wireless device has at least a portion made of metal. For example, housing of a wireless device may have a metal back cover, and/or a metal ring surrounding a rim of the wireless device. Display module (e.g., liquid crystal display module, LCM) exposed on an opening of wireless device may also be regarded as a metal portion of housing, because display module is packaged in a metal casing to be installed in wireless device.

Wireless device includes antenna for transmitting a feed signal as an outgoing wireless signal and/or receiving an incoming wireless signal as a feed signal. However, performance of antenna could be greatly degraded by metal portion of device housing. An antenna which can properly functions against metal portion is therefore demanded.

In a prior art, a gapped metal ring enclosing a rim of housing is grounded (tied to a ground voltage) to be utilized as an arm of an inverted F antenna, and is fed (i.e., connected to feed signal of an interior circuit board) via a conductive feed wire physically attached to the gapped metal ring by a conductive spring. However, such electrically conductive contact between feed and the grounded arm is mechanically vulnerable and unreliable, since it is in direct contact with the metal ring which bears mechanical impact, stress, pressure and deformation. When the conductive contact is loose, the antenna malfunctions.

### SUMMARY OF THE INVENTION

To address issues of prior arts, the present invention provides an antenna exploiting conductive interior structures and housing to form a ground component, and feeding the ground component by noncontact electrical coupling, so as to avoid disadvantages of feeding the grounded arm by physical contact.

An objective of the invention is providing an antenna for a device (e.g., wireless device); the antenna may include a conductive feed strip and a conductive ground component. The ground component is for connecting a ground voltage, and, a first portion (e.g., an outer portion) of the ground component may include a portion of a metal part along surface(s) (e.g., side surface(s), front surface and/or back surface) of the device. For example, the first portion may include a segment of a metal ring, which surrounds a rim (or partial rim) of the device. The feed strip may have a feed port for relaying (receiving and/or transmitting) a feed signal, and may not physically contact the ground component; e.g., current (flow of electrical charges) on the feed strip can not flow to the ground component, and current on the ground component can not flow to the feed strip.

In an embodiment, besides the first portion, the ground component may further include an inner portion extending to a contact of the metal part of the device, while the metal part is gapped by a gap. The first portion may include a segment of the metal part, and may extend from the contact and end at the gap of the metal part.

In an embodiment, the gap may be adjacent to an opening of the device; for example, the gap and the opening may be at a same side of the metal part. A part of the inner portion may be formed by a ground plane of a circuit board of the device, and another part of the inner portion may be formed by a conductive interior structure of the device, wherein the conductive interior structure may be connected between the ground plane and the contact of the metal part; for example, the conductive interior structure may be a conductive casing (frame) of an LCM of the device. Accordingly, the inner portion can extend to conductively connect the first portion. In an embodiment, the feed strip may be formed by a conductive layer of the circuit board, and the conductive layer may be insulated from the ground plane.

In an embodiment, the gap may be at a first surface of the device, and the inner portion may be formed by the ground plane and a conductive wall extending from the ground plane to an opening of the device, wherein the opening may be at a second surface of the device. For example, the first surface and the second surface may be perpendicular or nonparallel.

In an embodiment, the ground component may further include a tuning strip extending from an end of the first portion toward interior of the device.

In an embodiment, the feed strip may include a trunk, a first branch and a second branch. The trunk may extend from the feed port to a trunk end along a first direction, the first branch may extend from the trunk end along a second direction, and the second branch may extend from the trunk end along a third direction. The first direction and the second direction may be nonparallel or parallel; e.g., the first direction may be perpendicular to the second direction. The first direction and the third direction may be nonparallel or parallel; e.g., the first direction may be perpendicular to the third direction. The second direction and the third direction may be parallel or not.

In an embodiment, the antenna may further include a quantity (one or more) of conductive auxiliary strips. Each auxiliary strip may have an auxiliary ground terminal for connecting the ground voltage (e.g., the ground plane), may have no physical contact with the feed strip, and may extend without intersecting the ground component. For example, each auxiliary strip may extend along an offset contour of the feed strip.

The quantity of auxiliary strips may include a first quantity (zero or more) of first auxiliary strips and a second quantity (zero or more) of second auxiliary strips. Each first auxiliary strip may have an auxiliary ground terminal for connecting the ground voltage, may have no physical contact with the feed strip, and may include a division extending along an offset contour of the trunk and the first branch. Each second auxiliary strip may have an first auxiliary ground terminal for connecting the ground voltage, may have no physical contact with the feed strip, and may include a division extending along an offset contour of the trunk and the second branch.

In an embodiment, the antenna may further include a first switch and an additional strip. The first switch may be connected to a first node of the ground component. The additional strip may be conductive, and may be connected between the first switch and a second node of the ground component. The first switch is capable of selectively conducting between the additional strip and the first node.

In an embodiment, the antenna may further include a second switch connected to the ground component and separating the ground component into a tail section and a head section, and capable of selectively conducting between the tail section and the head section. For example, the head section may include the inner portion and the first portion of the ground component, and the tail section may include the tuning strip extending from the switch toward interior of the device; e.g., the second switch may be connected between the first portion and the tuning strip, and the first node and the second node may both be at the head section.

Numerous objects, features and advantages of the present invention will be readily apparent upon a reading of the following detailed description of embodiments of the present invention when taken in conjunction with the accompanying drawings. However, the drawings employed herein are for the purpose of descriptions and should not be regarded as limiting.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 illustrates an antenna according to an embodiment of the invention

FIG. 2 illustrates portions of the antenna shown in FIG. 1;

FIG. 3 illustrates operation of the antenna shown in FIG. 1;

FIG. 4 illustrates a conventional antenna;

FIG. 5 illustrates an antenna according to an embodiment of the invention;

FIG. 6 illustrates an antenna according to an embodiment of the invention;

FIG. 7 illustrates an antenna according to an embodiment of the invention;

FIG. 8 illustrates operation of the antenna shown in FIG. 7;

FIG. 9 illustrates an antenna according to an embodiment of the invention;

FIG. 10 illustrates an antenna according to an embodiment of the invention;

FIG. 11 to FIG. 14 illustrate operations of the antenna shown in FIG. 10;

FIG. 15 illustrates an antenna according to an embodiment of the invention;

FIG. 16 to FIG. 19 illustrate operations of the antenna shown in FIG. 15; and

FIG. 20 illustrates an impalement of the antenna shown in FIG. 10.

### DETAILED DESCRIPTION OF PREFERRED EMBODIMENTS

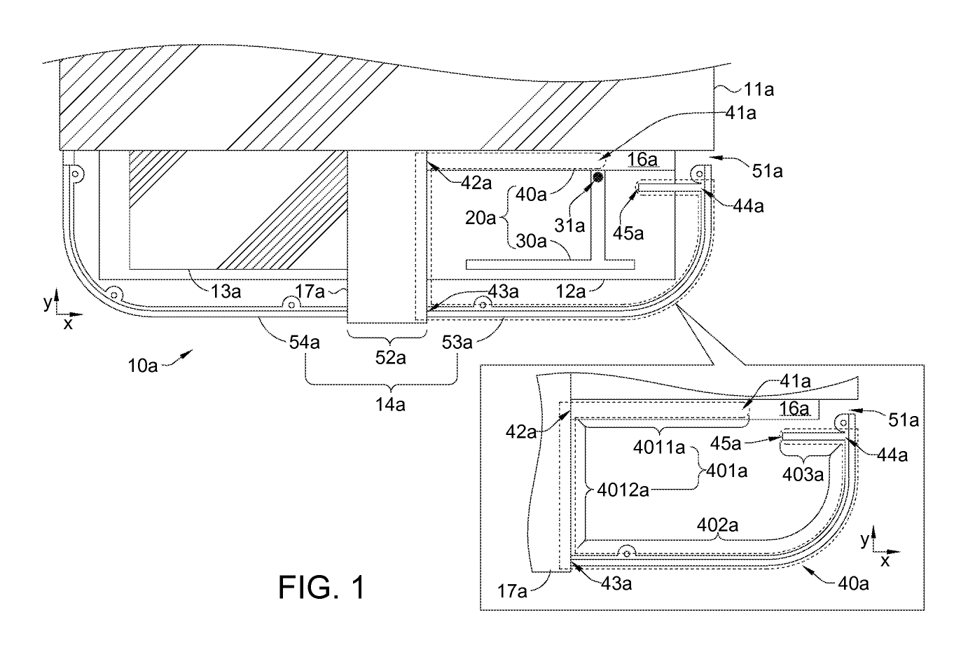

According to an embodiment of the invention, please refer to FIG. 1 illustrating an antenna 20a for a wireless device 10a. In addition to the antenna 20a embedded inside the device 10a, the device 10a may also include a circuit board 12a, a metal part 14a, and elements 11a, 13a and 17a. The metal part 14a may extend along surface(s) of the device 10; for example, the metal part 14a may include a portion extending along side surface(s) of the device 10a, such as a portion of a metal ring surrounding rim of the device 10a; and/or, the metal part 14 may include a portion extending along (flat or curved) front and/or back surface(s) of the device 10a, e.g., a portion of a back plate of the device 10a, and/or a decorative belt of a front plate of the device 10a. The metal part 14a may be gapped by a gap 51a, and may include an opening 52a between two segments 53a and 54a of the metal part 14a. In the embodiment of FIG. 1, the gap 51a and the opening 52a can be at different side surfaces of the device 10a, e.g., the gap 51a is at the right side surface and the opening 52a is at the bottom side surface of the device 10a.

The circuit board 12a, e.g., printed circuit board, may include a ground plane 16a connecting a ground voltage (not shown). Each of the elements 11a, 13a and 17a may be mounted on the circuit board 12a and packaged by conductive casing (e.g., conductive side walls) which may be kept at the ground voltage (e.g., by being connected to the ground plane 16a), hence the conductive casing can be regarded as a grounded conductive interior structure of the device 10a. For example, the element 11a may be an LCM exposed to a front surface of the device 10a, or a grounded metal back cover (back plate, back surface) of the device 10a; the element 13a may be a microphone module, a speaker module, a camera module, a flash-light module and/or a sensor module; and the element 17a may be an mechanical connection interface extruding to the opening 52a from the ground plane 16a, e.g., a USB (universal serial bus) connector or an audio jack; the element 17a may also be a button (e.g., power switch) for manual control, a sensor module, a stylus pen container and/or a slot for memory card or SIM (subscriber identity module) card.

The antenna 20a may include a strip (feed strip) 30a and a component (ground component) 40a. The strip 30a may have a feed port 31a for relaying a feed signal (not shown). From a position 41a in vicinity of the feed port 31a, the component 40a may extend to positions 42a, 43a, 44a, and ends at a position 45a, and may include three serially connected conductive portions 401a, 402a and 403a.

In the component 40a, the portion 401a may extend from the position 41a to the positions 42a and 43a, and may be regarded as an inner portion of the component 40a. The portion 402a may extend from the position 43a to the position 44a, and may be regarded as a first portion. The portion 403a may extend from the position 44a (the end of the portion 402a) to the position 45a, and may function as a tuning strip.

As shown in FIG. 1, the portion 401a may include two serially connected conductive parts 4011a and 4012a. The part 4011a may extend from the position 41a to the position 42a, and may be formed by the ground plane 16a; the part 4012a may extend from the position 42a to the position 43a, and may be formed by conductive interior structure of the element 17a. The conductive interior structure of the element 17a can be firmly engaged to the segment 53a at the position 43a to provide a mechanically reliable, durable and robust conductive contact between the portions 401a and 402a.

As illustrated in FIG. 1, the portion 402a may extend along surface(s) of the device 10a. The portion 402a may include a portion formed by segment(s) of a metal ring which surrounds side surface(s) of the device 10a, and/or may include a portion formed by a conductive portion of a back surface of the device 10a, and/or formed by a conductive portion of a decorative belt cross a front surface of the device 10a. For example, the portion 402a may include a segment of the metal part 14a, e.g., the segment 53a extending from position 43a, along two side surfaces (and a rounded corner in-between) of the device 10a, and ending at the gap 51a. By combining the portions 401a, 402a and 403a, the component 40a may form a grounded conductive G-shaped path which extends from the positions 41a, 42a, 43a, 44a to 45a, and surrounds the feed strip 30a without physically conductive contact or intersection.

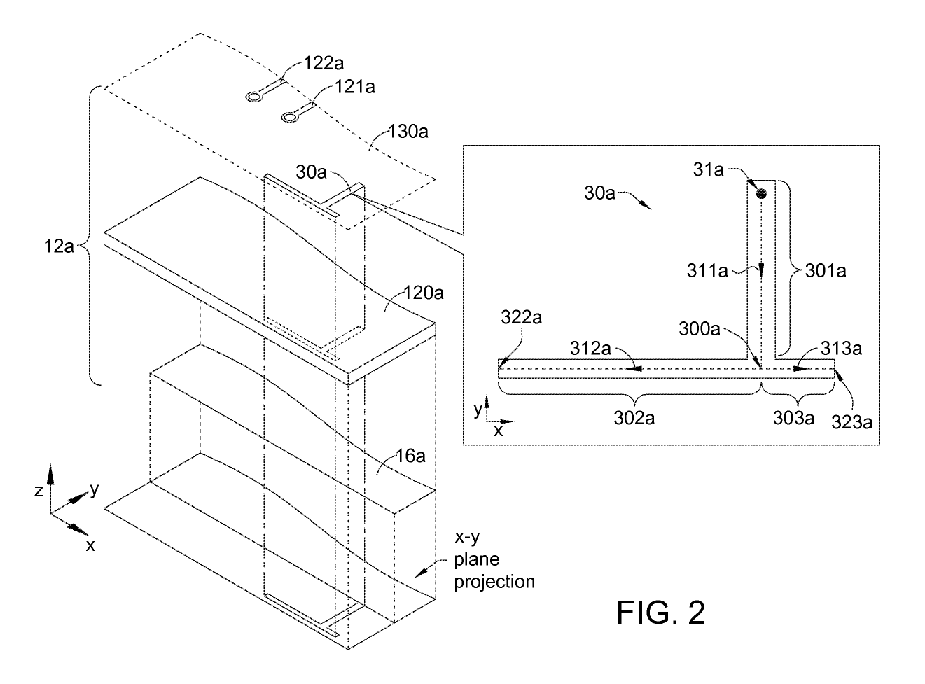

There may not be physical contact between the strip 30a and the component 40a, e.g. current on the strip 30a does not flow to the component 40a, and current on the ground component 40a does not flow to the strip 30a. Continuing the embodiment of FIG. 1, please refer to FIG. 2 illustrating an arrangement example of the strip 30a and the ground plane 16a according to an embodiment of the invention. The strip 30a may be formed by a conductive (e.g., metal) layer 130a of the circuit board 12a; the layer 130a and the ground plane 16a may be respectively attached to opposite surfaces of an intermediate structure 120a which interfaces the layer 130a and the ground plane 16a by dielectric material. Accordingly, though x-y plane projection of the strip 30a and the ground plane 16a may look close or even overlapping (e.g., at the feed port 31a and the nearby position 41a, FIG. 1), the strip 30a actually does not physically contact the ground plane 16a along z-axis, without any physical current conduction path between them.

Besides the strip 30a, the layer 130a may include other conductive routing, such as wires 121a and 122a. The intermediate structure 120a may be a dielectric layer; alternatively, the intermediate structure 120a may include other conductive layer(s) (not shown) and dielectric layers (not shown), wherein each conductive layer can be sandwiched between two adjacent dielectric layers.

As shown in FIG. 2, the strip 30a may include a trunk 301a and two branches 302a and 303a. The trunk 301 a may extend from the feed port 31a to an end 300a (trunk end) along a direction 311a, the branch 302a may extend from the end 300a to another end 322a along a direction 312a, and the branch 303a may extend from the end 300a to another end 323a along a direction 313a. The directions 311a and 312a may be parallel or nonparallel; e.g., the directions 311a and 312a may be perpendicular. The directions 311a and 313a may be parallel or nonparallel; e.g., the directions 311a and 313a may be perpendicular. The directions 312a and 313a may be parallel. In an embodiment, the strip 30a may include only one of the two branches 302a and 303a. In an embodiment, each of the branches 302a and 303a may include other branch (or branches) (not shown); for example, the branch 302a may include another branch (not shown) extending from the end 322a, or any position between the ends 300a and 322a. Though the trunk 301a may connect to the branch 302a by a sharp turn as shown in FIG. 2, the trunk 301a may connect to the branch 302a by a chamfer or a fillet, e.g., the trunk 301a may transit to the branch 302a by a J-shaped connection.

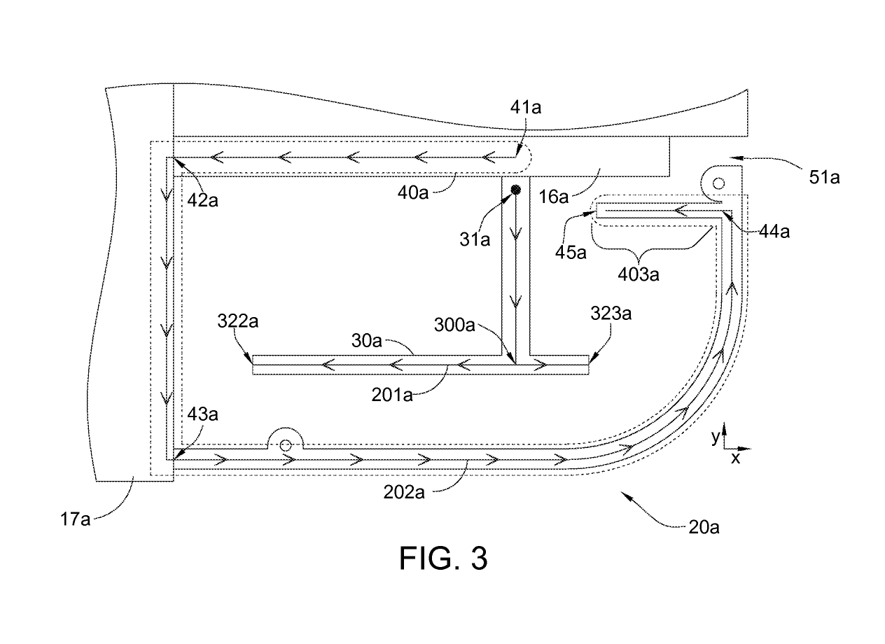

Continuing the embodiment of FIG. 1 and FIG. 2, please refer to FIG. 3 illustrating operation of the antenna 20a. The feed strip 30a is capable of providing a current distribution path 201a which extends from the feed port 31a to the ends 300a, 322a and 323a, and therefore providing a high-band (high-frequency band) path for wireless transmission and/or receiving at high-band. The feed strip 30a may also work to feed the component 40a by noncontact electrical coupling, and the component 40a is capable of providing another current distribution path 202a extending from the position 41a to the positions 42a, 43a, 44a and 45a, so as to provide a low-band (low-frequency band) path for wireless transmission and/or receiving at low-band. For antenna design flexibility, dimensions of the strip 30a (e.g., length between the feed port 31a to the end 300a, length between the ends 300a and 322a, and/or length between the ends 300a and 323a) may be adjusted to tune performance and characteristics (e.g., upper/lower frequency bounds, bandwidth and/or central resonance frequency) of the high-band; likewise, dimensions of the component 40a (e.g., length of the tuning strip portion 403a between the positions 44a and 45a) may be adjusted to tune performance and/or characteristics of the low-band. In addition, distances between the strip 30a and the component 40a may also be adjusted to tune performance and/or characteristics of the antenna.

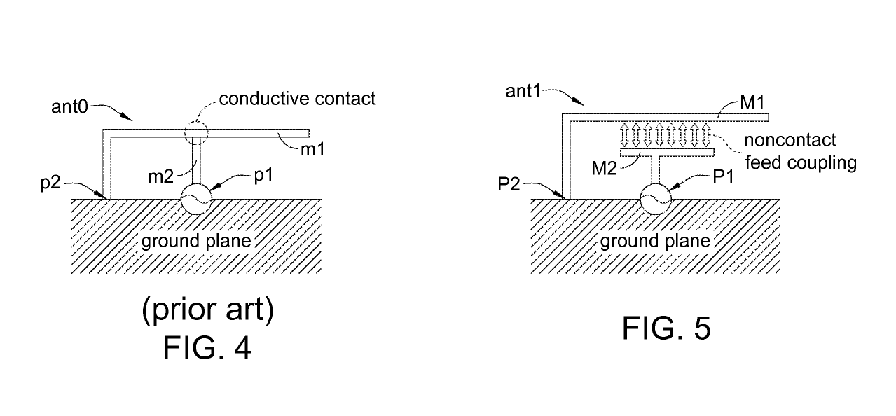

Please refer to FIG. 4 and FIG. 5; schematically, FIG. 4 illustrates a prior antenna ant0 and FIG. 5 illustrates an antenna ant1 according to an embodiment of the invention. As shown in FIG. 4, the antenna ant0 includes a conductive L-shaped arm m1 having an end connected to a ground plane, along with a conductive strip m2 which is fed at a port p1 against the ground plane, and is connected to the arm m1 by physical conductive contact, hence the arm m1 and the strip m2 combines to form an inverted F antenna. However, while the arm m1 is formed by metal ring of device, the conductive contact connecting the arm m1 and the strip m2 is mechanically weak and unreliable. On the contrary, as shown in FIG. 5, the antenna ant1 may include a conductive component M1 and a conductive strip M2 which does not physically contact the component M1; i.e., there is no electrically conductive contact (conductor connection) between the component M1 and the strip M2. Feed signal at the feed port P1 can be fed to the component M1 via electrically noncontact feed coupling. Therefore, mechanical unreliable connection between the grounded component and the feed port is avoided. Note that the component M1 and the strip M2 of the antenna ant1 can respectively be implemented by the component 40a and the strip 30a of the antenna 20a (shown in FIG. 1), so the antenna 20a can operate by leveraging feed coupling.

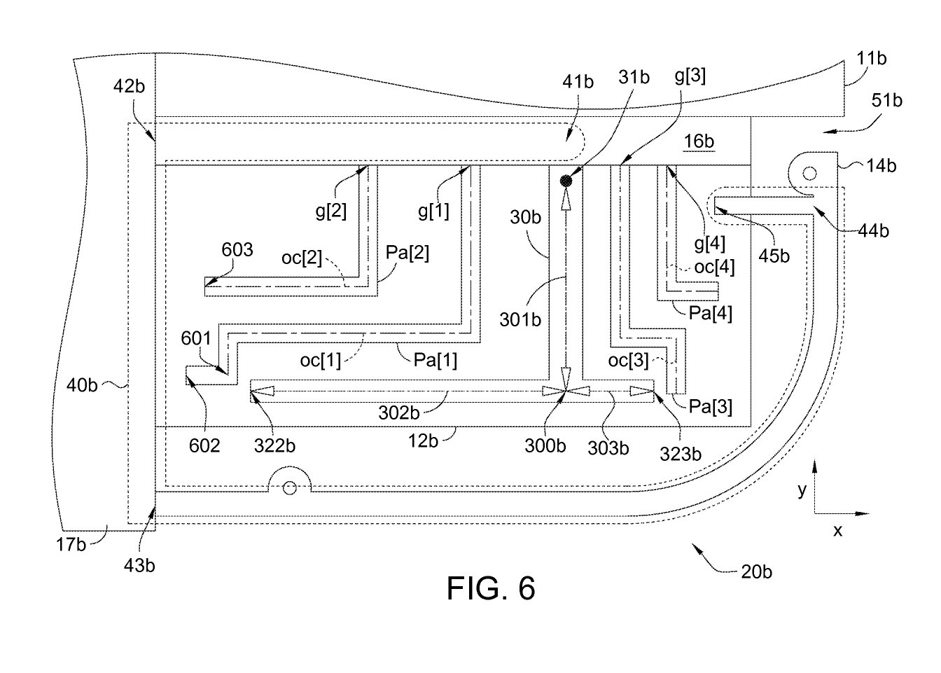

Please refer to FIG. 6 illustrating an antenna 20b according to an embodiment of the invention. Similar to the antenna 20a shown in FIG. 1, the antenna 20b shown in FIG. 6 may include a strip 30b and a component 40b which does not physically contact the strip 30b. The strip 30b can be made of conductive material, may have a feed port 31b, and may include a trunk 301b and two branches 302b and 303b. The trunk 301b may extend from the feed port 31 b to an end 300b, and the branches 302b and 303b may respectively branch to two ends 322b and 323b from the end 300b.

The component 40b may be connected to a ground voltage (not shown); from a position 41b near the feed port 31b, the component 40b may extend to positions 42b, 43b, 44b and 45b, and may be formed by conductive portions which are serially connected by electrically conductive contacts, e.g., an inner portion extending from the position 41b to the positions 42b and 43b, a first portion between the positions 43b and 44b, and a tuning strip portion between the positions 44b and 45b. The inner portion may be provided by a ground plane 16b of a circuit board 12b, along with an interior conductive structure of an element 17b. The first portion may be a segment of a metal part (e.g., a metal ring) 14b, which can be gapped by a gap 51b.

Besides the strip 30b and the component 40b, the antenna 20b may further include one or more auxiliary strips as parasitic strips, such as strips Pa[1], Pa[2], P[a3] and Pa[4]. The strips Pa[1] to Pa[4] may respectively have terminals g[1], g[2], g[3] and g[4] for connecting the ground voltage, may not physically contact the strip 30b, and may extend without intersecting the component 40b; e.g., each strip Pa[n] of the strips Pa[1] to Pa[4] may not have to electrically contact the component 40b except at the terminal g[n]. For example, one, some or all of the auxiliary strips Pa[1] to Pa[4] may be formed by a first conductive layer where the ground plane 16b resides. And/or, while the strip 30b may be formed by another second conductive layer (not shown) of the circuit board 12b with the second conductive layer insulated from the first conductive layer of the ground plane 16b, one, some or all of the auxiliary strips Pa[1] to Pa[4] may be formed by the second conductive layer; the strip Pa[n] formed by the second conductive layer may be connected to the ground plane 16b by conductive via(s) at the terminal g[n], and there can be no physical contact between the strip 30b and each strip Pa[n].

In an embodiment, a strip Pa[n] may extend along an offset contour of the strip 30b; alternatively, a strip Pa[n] may at least have a division extending along an offset contour of the strip 30b. For example, the strip Pa[2] may extend from the terminal g[2] to a position 603 along an offset contour oc[2] of the trunk 301b and the branch 302b. Similarly, the strips Pa[3] and Pa[4] may respectively extend along offset contours oc[3] and oc[4] of the trunk 301b and the branch 303b. On the other hand, the strip Pa[1] may include a first division extending from the terminal g[1] to an intermediate position 601 along an offset contour oc[1] of the trunk 301b and the branch 302b, and a second division extending from the position 601 to a position 602 of the strip Pa[1], wherein the second division does not have to track offset contour of the strip 30b. The antenna of the invention may have more or fewer auxiliary strips than the strips Pa[1] to Pa[4]; the auxiliary strip(s) can be utilized to tune characteristics and/or performance of the antenna 20b.

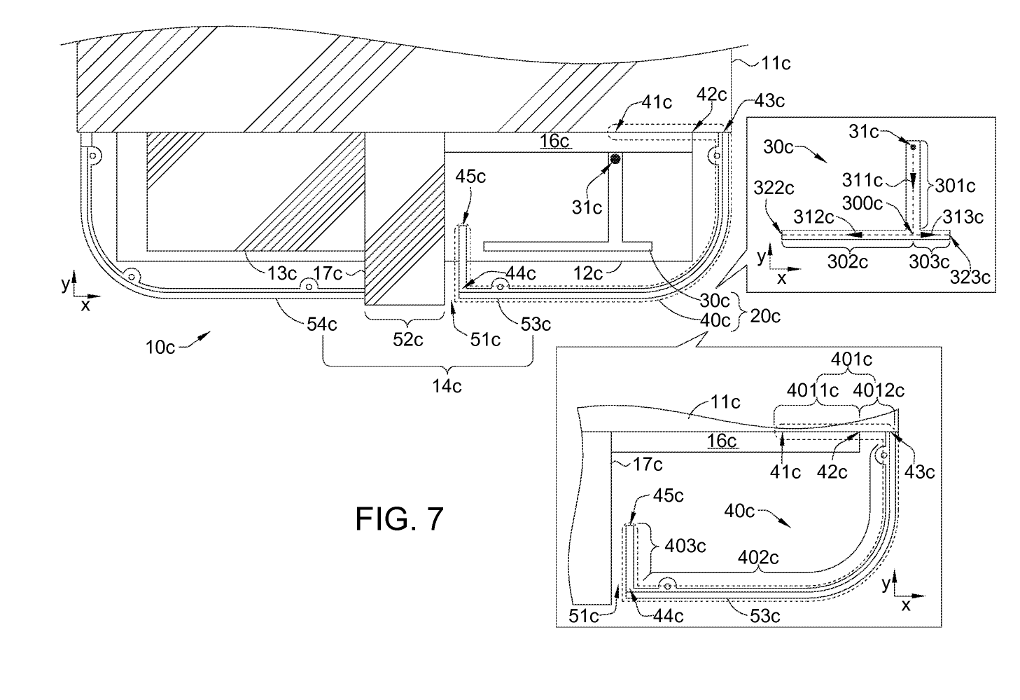

Please refer to FIG. 7 illustrating an antenna 20c of a wireless device 10c, according to an embodiment of the invention. The device 10c may include a circuit board 12c, interior elements 11c, 13c and 17c mounted on the circuit board 12c, a metal part 14c along surface(s) of the device 10c, with the antenna 20c embedded in the device 10c. Similar to the metal part 14a shown in FIG. 1, the metal part 14c in FIG. 7 may include a portion formed by segment(s) of a metal ring which surrounds side surface(s) of the device 10c, and/or may include a portion formed by a conductive portion of a back surface of the device 10c, and/or formed by a conductive portion of a decorative belt cross a front surface of the device 10c. The metal part 14a may include two segments 53c and 54c with an opening 52c in-between, and may be gapped by a gap 51c adjacent to the opening 52c; e.g., the gap 51c and the opening 52c are at a same side (e.g., bottom or top side) of the device 10c.

The circuit board 12c, e.g., printed circuit board, may include a ground plane 16c connecting a ground voltage (not shown). Each of the elements 11c, 13c and 17c may be packaged by conductive casing (e.g., conductive side walls) which is kept at the ground voltage, e.g., electrically connects the ground plane 16c by conductive contact, hence the conductive casing can be regarded as a grounded conductive interior structure. For example, the element 11c may be an LCM; the element 13c may be a microphone module, a speaker module, a camera module, a flash-light module and/or a sensor module; and the element 17c extruding to the opening 52c from the ground plane 16c may be a USB connector, an audio jack, a button (e.g., power switch) for manual control, an externally exposed sensor module, a stylus pen container and/or a containing slot for memory card or SIM card.

The antenna 20c may include a strip 30c as a feed strip and a component 40c as a ground component. The strip 30c may have a feed port 31c for relaying a feed signal (not shown). The component 40c may extend from a position 41c to positions 42c, 43c, 44c, and ends at a position 45c, and may include three serially connected conductive portions 401c, 402c and 403c. The portion 402c may include a portion formed by segment(s) of a metal ring which surrounds side surface(s) of the device 10c, and/or may include a portion formed by a conductive portion of a back surface of the device 10c, and/or formed by a conductive portion of a decorative belt cross a front surface of the device 10c.

From the position 41c in vicinity of feed port 31c, the portion 401c of the component 40c may extend to the positions 42c and 43c, and may be regarded as an inner portion of the component 40c. The portion 402c may extend from the position 43c to the position 44c, and may be regarded as a first portion. The portion 403c, may extend from the position 44c (the end of the portion 402c) to the position 45c, and may function as a tuning strip.

As shown in FIG. 7, the portion 401c may include two serially connected parts 4011c and 4012c. The part 4011c may extend from the position 41c to the position 42c, and may be formed by the ground plane 16c along with the conductive interior structure of the element 11c; the part 4012c may extend from the position 42c to the position 43c and may be formed by conductive interior structure of the element 11c. At the position 43c, the conductive interior structure of the element 11c may be firmly engaged to the segment 53c of the metal part 14c to provide a mechanically reliable, durable and robust conductive contact between the portions 401c and 402c.

The portion 402c may extend along surface(s) (e.g., two side surfaces and a rounded corned in-between) of the device 10c. For example, the portion 402c may include a segment of the metal part 14c, e.g., the segment 53c extending from position 43c and ending at the gap 51c. By combining the portions 401c, 402c and 403c, the component 40c may form a grounded conductive path which extends from the positions 41c, 42c, 43c, 44c to 45c, and may surround the feed strip 30c without physically conductive contact or intersection.

There may be no physical contact between the strip 30c and the component 40c, e.g. current on the strip 30c does not flow to the component 40c, and current on the ground component 40c does not flow to the strip 30c. The strip 30c may include a trunk 301c and two branches 302c and 303c. The trunk 301c may extend from the feed port 31c to an end 300c along a direction 311c, the branch 302c may extend from the end 300c to another end 322c along a direction 312c, and the branch 303c may extend from the end 300c to another end 323c along a direction 313c. The directions 311c and 312c may be perpendicular or not. The directions 311c and 313c may be perpendicular or not.

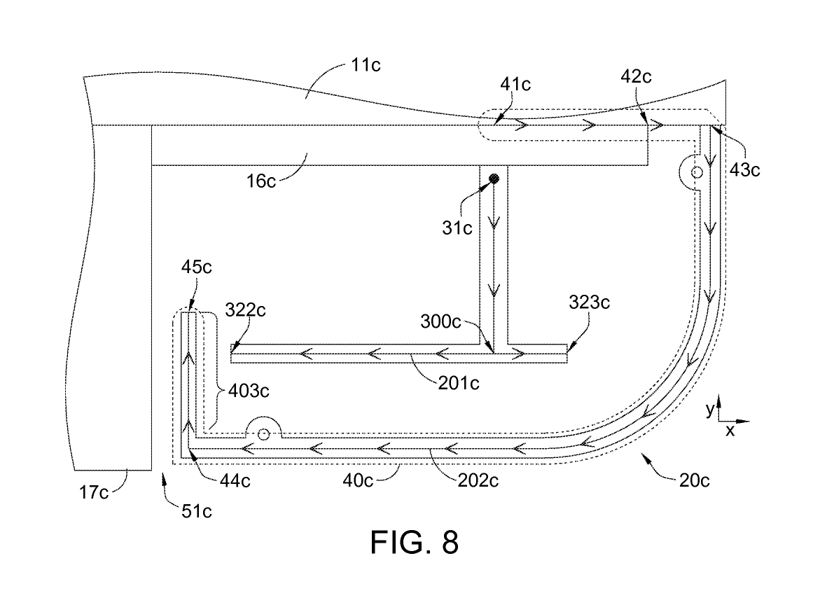

Continuing the embodiment of FIG. 7, please refer to FIG. 8 illustrating operation of the antenna 20c. The feed strip 30c is capable of providing a current distribution path 201c which extends from the feed port 31c to the ends 300c, 322c and 323c, and therefore providing a high-band path for wireless transmission and/or receiving at high-band. The feed strip 30c may also work to feed the component 40c by distant electrical coupling, and the component 40c is capable of providing another current distribution path 202c extending from the position 41c to the positions 42c, 43c, 44c and 45c, so as to provide a low-band path for wireless transmission and/or receiving at low-band. For antenna design flexibility, dimensions of the strip 30c (e.g., length between the feed port 31c to the end 300c, length between the ends 300c and 322c, and/or length between the ends 300c and 323c) may be adjusted to tune performance and characteristics of the high-band; likewise, dimensions of the component 40c (e.g., length of the tuning strip portion 403c between the positions 44c and 45c) may be adjusted to tune performance and/or characteristics of the low-band. Furthermore, distances between the strip 30c and the component 40c may also be adjusted to tune performance and/or characteristics of antenna.

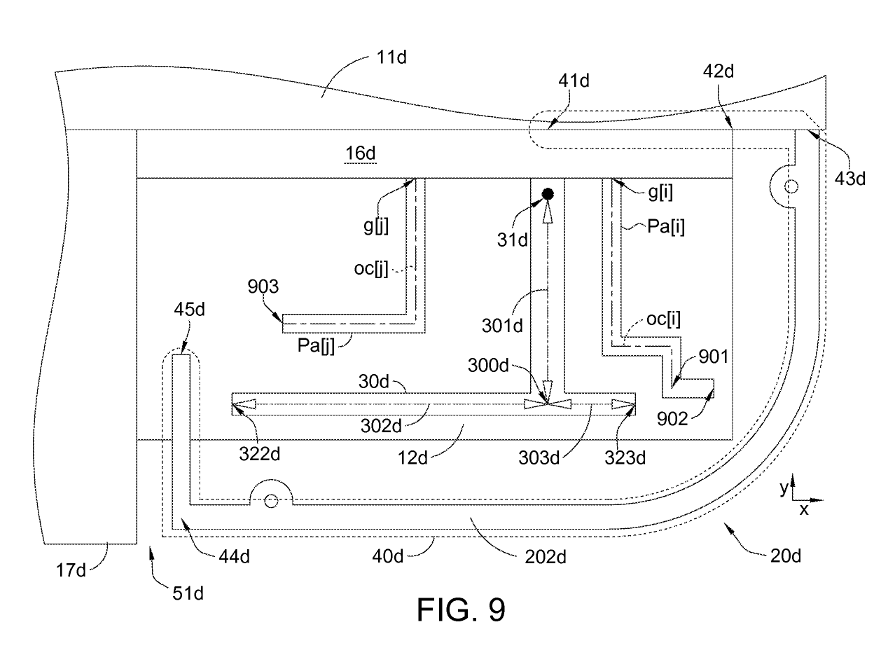

Please refer to FIG. 9 illustrating an antenna 20d according to an embodiment of the invention. Similar to the antenna 20c shown in FIG. 7, the antenna 20d shown in FIG. 9 may include a conductive strip 30d and a conductive component 40d which does not physically contact the strip 30d. The strip 30d may have a feed port 31d, and may include a trunk 301d and two branches 302d and 303d. The trunk 301d may extend from the feed port 31d to an end 300d, and the branches 302d and 303d may respectively branch to two ends 322d and 323d from the end 300d.

The component 40d may be connected to a ground voltage (not shown); from a position 41d near the feed port 31d, the component 40d may extend to positions 42d, 43d, 44d and 45d, and may be formed by portions which are serially connected by electrically conductive contacts, e.g., an inner portion extending from the position 41d to the positions 42d and 43d, a first portion between the positions 43d and 44d, and a tuning strip portion between the positions 44d and 45d. The inner portion may be provided by a ground plane 16d of a circuit board 12d, along with an interior conductive structure of an element 11d. The first portion may be a segment of a metal part 14d, which may be gapped by a gap 51d adjacent to an element 17d.

Besides the strip 30d and the component 40d, the antenna 40d may further include one or more auxiliary strips as parasitic strips, such as strips Pa[i] and Pa[j]. The strips Pa[i] and Pa[j] may respectively have terminals g[i] and g[j] for connecting the ground voltage, may not physically contact the strip 30d, and may extend without intersecting the component 40d; e.g., the strips Pa[i] and Pa[j] do not have to conductively contact the component 40d except at the terminal g[i] and g[j]. For example, one or both of the auxiliary strips Pa[i] and Pa[j] may be formed by a first conductive layer which also forms the ground plane 16d. And/or, while the strip 30d may be formed by a second conductive layer (not shown) of the circuit board 12d with the second conductive layer insulated from the first conductive layer of the ground plane 16d, one or both of the auxiliary strips Pa[i] and Pa[j] may also be formed by the second conductive layer; the strip(s) Pa[i] and/or Pa[j] formed by the second conductive layer may be connected to the ground plane 16d by conductive via(s) at the terminal g[i] and/or g[j], and there may be no physical contact between the strip 30d and each of the strip Pa[i] and Pa[j].

In an embodiment, each of the strips Pa[i] and Pa[j] may have at least a division extending along an offset contour of the strip 30d. For example, the strip Pa[j] may extend from the terminal g[j] to a position 903 along an offset contour oc[i] of the trunk 301d and the branch 302d. The strip Pa[i] may include a first division and a second division; the first division may extend from the terminal g[i] to an intermediate position 901 along an offset contour oc[i] of the trunk 301d and the branch 303d, and the second division may extend from the position 901 to a position 902 of the strip Pa[i], wherein the second division does not have to track offset contour of the strip 30d. The antenna of the invention may have more or fewer auxiliary strips than the strips Pa[i] and Pa[j]; the auxiliary strip(s) can be utilized to tune characteristics and/or performance of the antenna 20d.

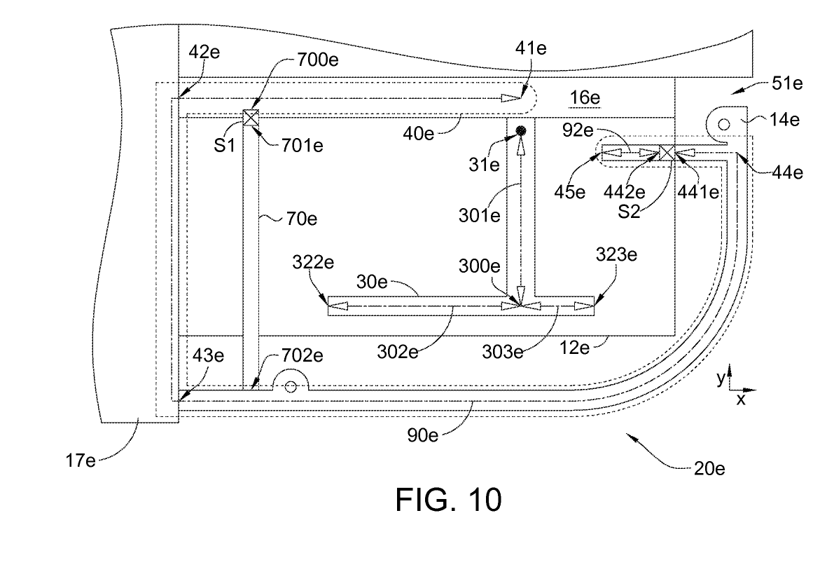

Please refer to FIG. 10 illustrating an antenna 20e according to an embodiment of the invention. Similar to the antenna 20a shown in FIG. 1, the antenna 20e in FIG. 9 may include a feed strip 30e and a ground component 40e; moreover, the antenna 20e may further include an additional strip 70e and two switches S1 and S2.

The strip 30e may have a feed port 31e, and may include a conductive trunk 301e and two conductive branches 302e and 303e electrically connected to the trunk 301e by conductive contact. The trunk 301e may extend from the feed port 31e to an end 300e, where the two branches 302e and 303e may respectively branch to two ends 322e and 323e. The strip 30e may not physically contact the component 40e, the strip 70e and the switches S1 and S2.

The component 40e may be connected to a ground voltage (not shown), and may be separated into two sections 90e and 92e (head and tail sections) by the switch S2. From a position 41e near the feed port 31e, the head section 90e may extend via positions 42e, 43e, 44e to a position 441e (a node), and may be formed by portions which are serially connected by conductive contacts; the portions may include an inner portion extending from the position 41e to the positions 42e and 43e, as well as a first portion extending from the positions 43e to the positions 44e and 441e. The inner portion may be provided by a ground plane 16e of a circuit board 12e, along with an interior conductive structure of an element 17e. The first portion may be provided by a segment of a metal part 14e, which may be gapped by a gap 51e near the positions 44e and 441e.

On the other hand, the tail section 92e of the component 40e may be a tuning strip portion extending from a position 442e (a node) to a position 45e, i.e., extending from the switch S2 toward interior of wireless device. The switch S2 is capable of selectively conducting between the two positions 441e and 442e, i.e., capable of selectively conducting between the two sections 90e and 92e.

The switch S1 may be connected between a position 700e (first node) of the component 40e and a position 701e of the strip 70e. The additional strip 70e may extend from position 701 e to a position 702e (second node) of the component 40e; at the position 702e, the conductive strip 70e can be electrically connected to the component 40e by conductive contact. The switch S1 is capable of selectively conducting between the strip 70e and the position 700e of the component 40e.

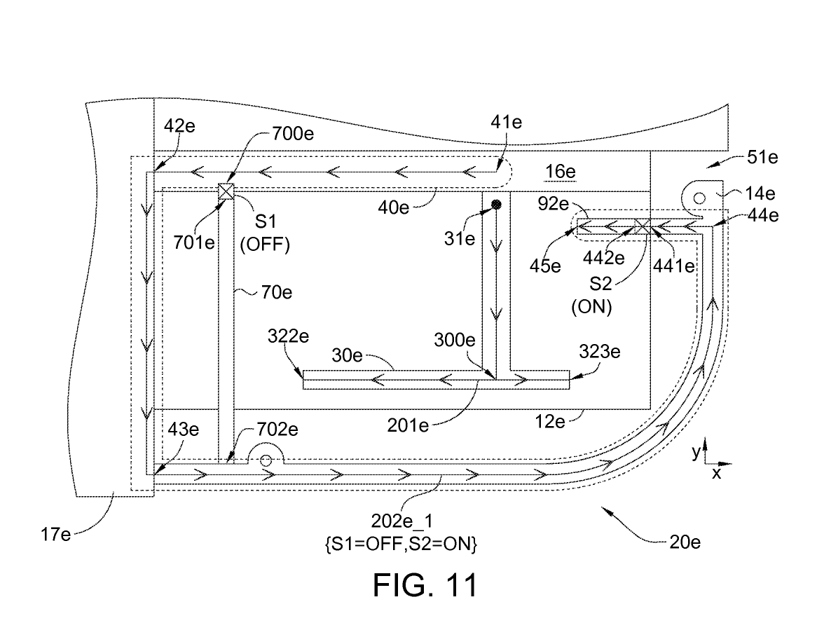

Continuing the embodiment of FIG. 10, please refer to FIG. 11 to FIG. 14 illustrating operations of the antenna 20e shown in FIG. 10. As shown in FIG. 11 to FIG. 14, the strip 30e is capable of providing a current distribution path 201e for resonation of a wireless high-band. Furthermore, according to whether the switches S1 and S2 are on (conducting) or off (not conducting), the antenna 20e is capable of providing different bands, e.g., different low-bands.

In FIG. 11, the switch S1 is off (not conducting) and the switch S2 is on (conducting), the strip 70e is therefore bypassed by the turned-off switch S1, but the position 441e can be conducted to the position 442e by the turned-on switch S2. Accordingly, from the position 41e near the feed port 31e, the antenna 20e can provide a current distribution path 202e_1 extending via the positions 42e, 43e, 44e, 441e and 442e to the position 45e for resonation of a first low-band.

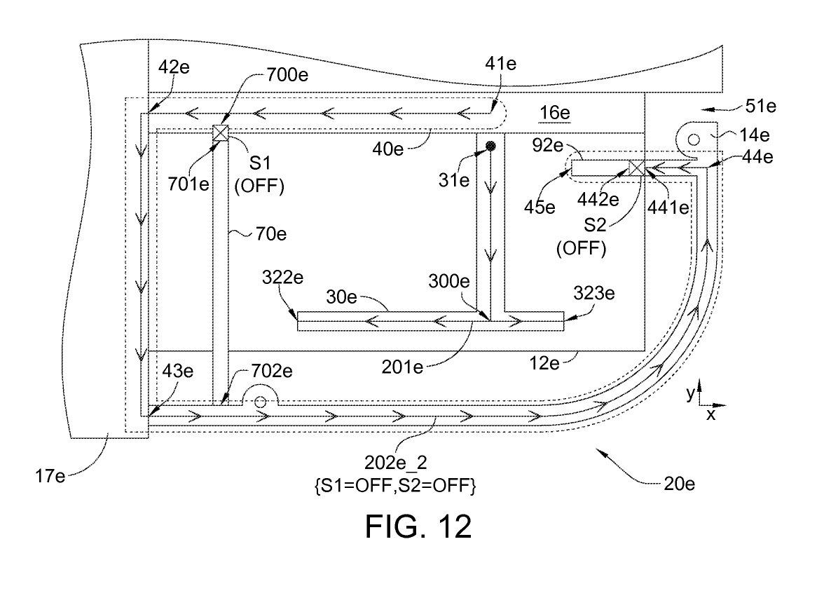

In FIG. 12, the switch S1 is off and the switch S2 is also off, hence the strip 70e is bypassed, and the position 441e is not conducted to the position 442e. Accordingly, the antenna 20e can provide a current distribution path 202e_2 extending from the position 41e to the positions 42e, 43e, 44e and 441e for resonation of a second low-band. Because the turned-off switch S2 keeps the section 92e electrically disconnected from the position 441e, the path 202e_2 is shorter than the path 202e_1 in FIG. 11, and frequency of the second low-band can be higher than that of the first low-band.

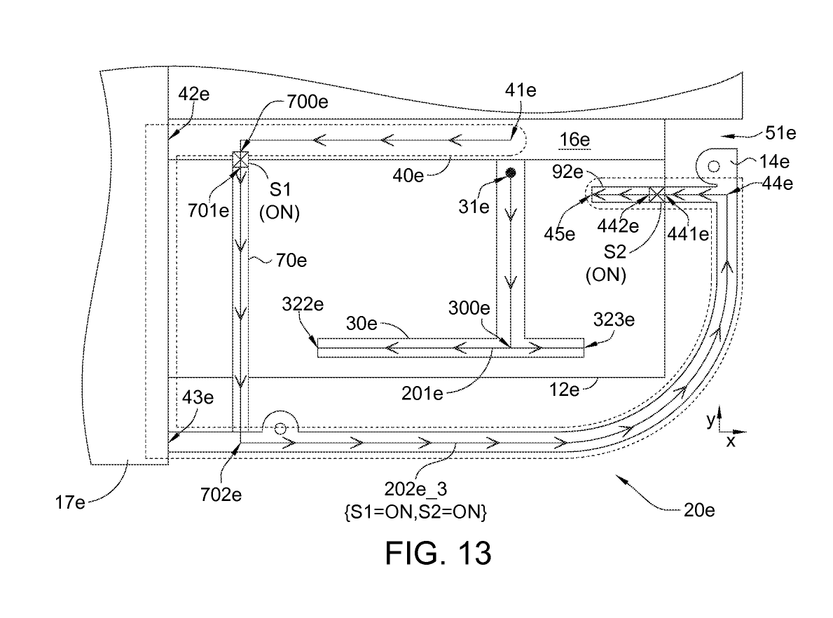

In FIG. 13, the switch S1 is on and the switch S2 is also on, hence the strip 70e is electrically connected to the position 701e to form a short cut from the position 700e of the ground plane 16e to the position 702e of the metal part 14e. Accordingly, the antenna 20e can provide a current distribution path 202e_3 extending from the position 41e to the positions 700e, 701e, 702e, 44e, 441e, 442e and 45e for resonation of a third low-band. Because of the short cut provided by the turned-on switch S1 and the strip 70e, length of the path 202e_3 is shorter than the path 202e_1 in FIG. 11, and frequency of the third low-band can be higher than that of the first low-band.

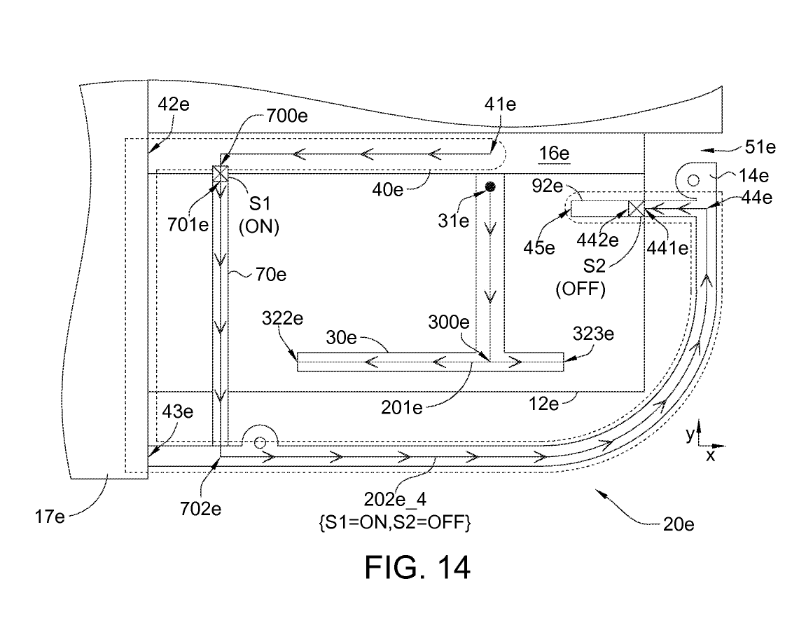

In FIG. 14, the switch S1 is on but the switch S2 is off. Accordingly, the antenna 20e can provide a current distribution path 202e_4 extending from the position 41e to the positions 700e, 701e, 702e, 44e and 441e for providing a fourth low-band. Comparing to the paths 202e_1 to 202e_3 respectively shown in FIG. 11 to FIG. 13, length of the path 202e_4 is the shortest, so frequency of the fourth low-band can be higher than frequencies of the first to third low-bands.

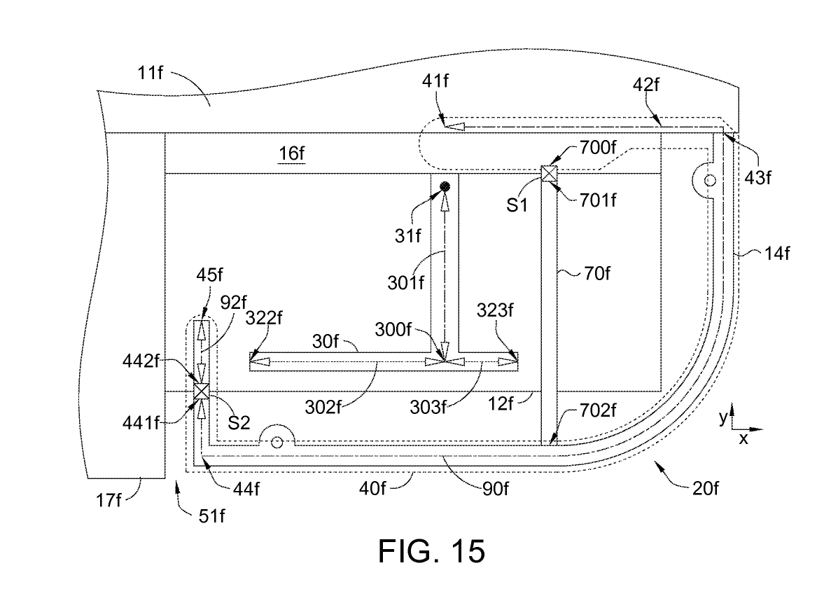

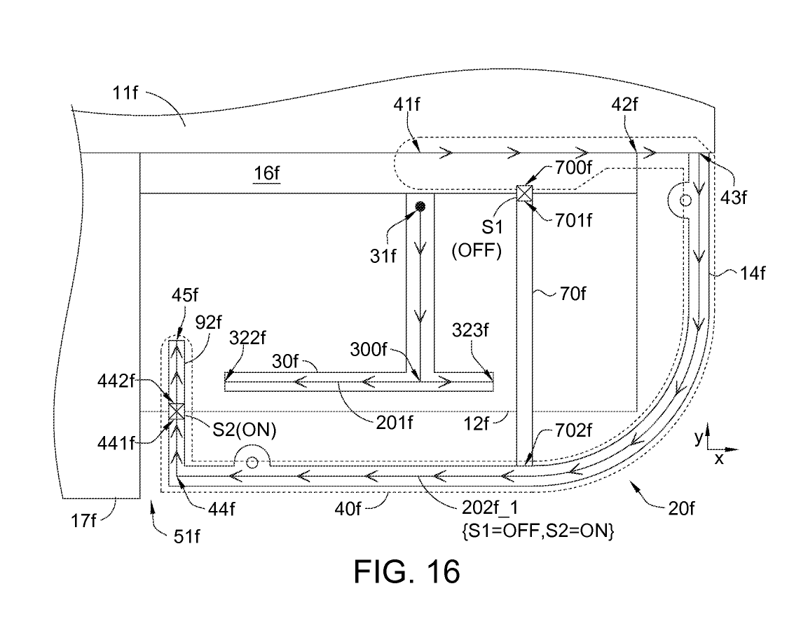

Please refer to FIG. 15 illustrating an antenna 20f according to an embodiment of the invention. Similar to the antenna 20c shown in FIG. 7, the antenna 20f in FIG. 15 may include a conductive feed strip 30f and a conductive ground component 40f; in addition, the antenna 20f may further include an additional strip 70f and two switches S1 and S2.

The strip 30f may have a feed port 31f, and may include a conductive trunk 301f and two conductive branches 302f and 303f. The trunk 301f may extend from the feed port 31f to an end 300f, where the two branches 302f and 303f may respectively branch to two ends 322f and 323f. The strip 30f may not physically contact the component 40f, the strip 70f and the switches S1 and S2.

The component 40f may be connected to a ground voltage (not shown), and may be separated into two sections 90f and 92f (head and tail sections) by the switch S2. From a position 41f near the feed port 31f, the head section 90f may extend via positions 42f, 43f, 44f to a position 441f (a node), and may be formed by portions which are serially connected by conductive contacts; the portions may include an inner portion extending from the position 41f to the positions 42f and 43f, as well as a first portion extending from the positions 43f to the positions 44f and 441f. The inner portion may include a part provided by a ground plane 16f of a circuit board 12f, along with another part provided by an interior conductive structure of an element 11f. The first portion may be provided by a segment of a metal part 14f, which may be gapped by a gap 51 f near the positions 44f and 441f.

On the other hand, the tail section 92f of the component 40f may be a tuning strip extending from a position 442f (a node) to a position 45f, i.e., extending from the switch S2 toward interior of wireless device. The switch S2 is capable of selectively conducting between the two positions 441f and 442f, i.e., between the two sections 90f and 92f.

The switch S1 may be connected between a position 700f (first node) of the component 40f and a position 701f of the strip 70f. The additional strip 70f may extend from the position 701f to a position 702f (second node) of the component 40f; at the position 702f, the conductive strip 70f may be connected to the component 40f by conductive contact. The switch S1 is capable of selectively conducting between the strip 70f and the position 700f of the component 40f.

Continuing the embodiment of FIG. 15, please refer to FIG. 16 to FIG. 19 illustrating operations of the antenna 20f shown in FIG. 15. As shown in FIG. 16 to FIG. 19, the strip 30f is capable of providing a current distribution path 201f for providing a wireless high-band. Furthermore, according to whether the switches S1 and S2 are on or off, the antenna 20f is capable of providing different bands, e.g., different low-bands.

In FIG. 16, the switch S1 is off (not conducting) and the switch S2 is on (conducting), the strip 70f may therefore be bypassed by the turned-off switch S1, but the position 441f can be conducted to the position 442f by the turned-on switch S2. Accordingly, from the position 41f, the antenna 20f can provide a current distribution path 202f_1 extending via the positions 42f, 43f, 44f, 441f and 442f to the position 45f for providing a first low-band.

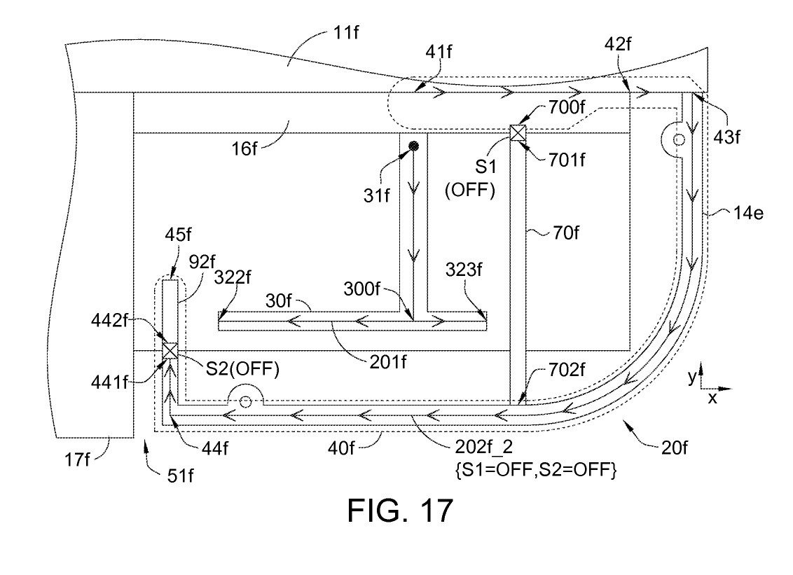

In FIG. 17, the switches S1 and S2 are both off, so the strip 70f may be bypassed, and the position 441f is not conducted to the position 442f. Accordingly, the antenna 20f can provide a current distribution path 202f_2 extending from the position 41f to the positions 42f, 43f, 44f and 441f for a second low-band. Because the turned-off switch S2 may keep the section 92f electrically disconnected from the position 441f, the path 202f_2 may be shorter than the path 202f_1 in FIG. 16, and frequency of the second low-band can be higher than that of the first low-band.

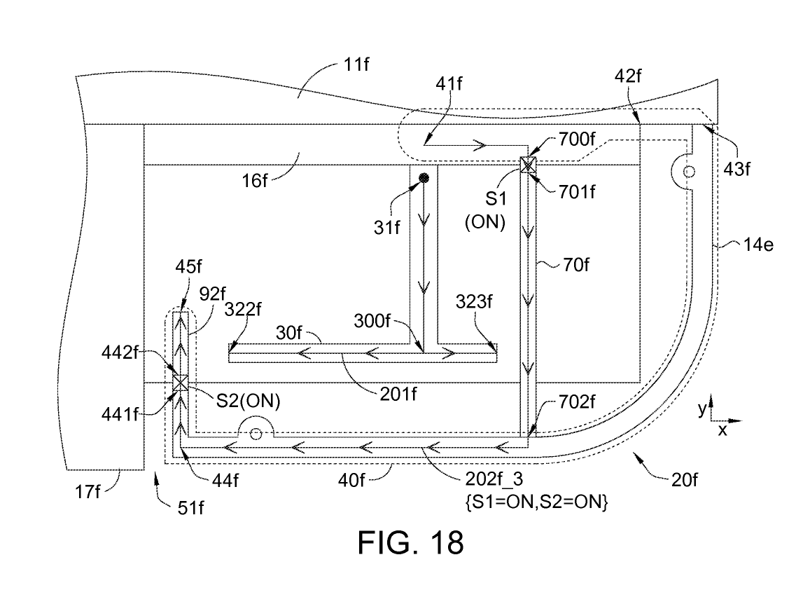

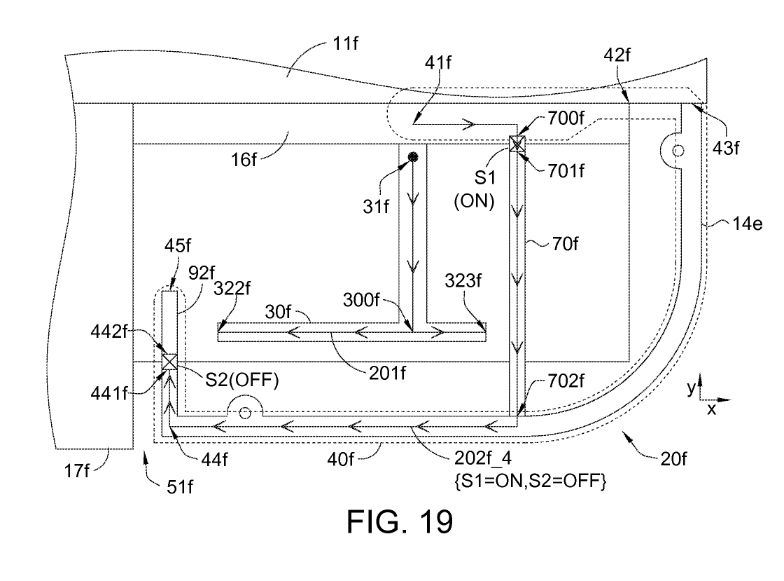

In FIG. 18, both the switches S1 and S2 are turned on, hence the strip 70f may be electrically connected to the position 701f to form a detour from the position 700f to the position 702f. Accordingly, the antenna 20f can provide a current distribution path 202f_3 extending from the position 41f to the positions 700f, 701f, 702f, 44f, 441f, 442f and 45f for providing a third low-band. Because length of the path 202f_3 is shorter than the path 202f_1 in FIG. 16, frequency of the third low-band can be higher than that of the first low-band.

In FIG. 19, the switch S1 is on but the switch S2 is off. Accordingly, the antenna 20f can provide a current distribution path 202f_4 extending from the position 41f to the positions 700f, 701f, 702f, 44f and 441f for providing a fourth low-band. Comparing to the paths 202f_1 to 202f_3 respectively shown in FIG. 16 to FIG. 18, length of the path 202f_4 is the shortest, so frequency of the fourth low-band can be higher than frequencies of the first to third low-bands.

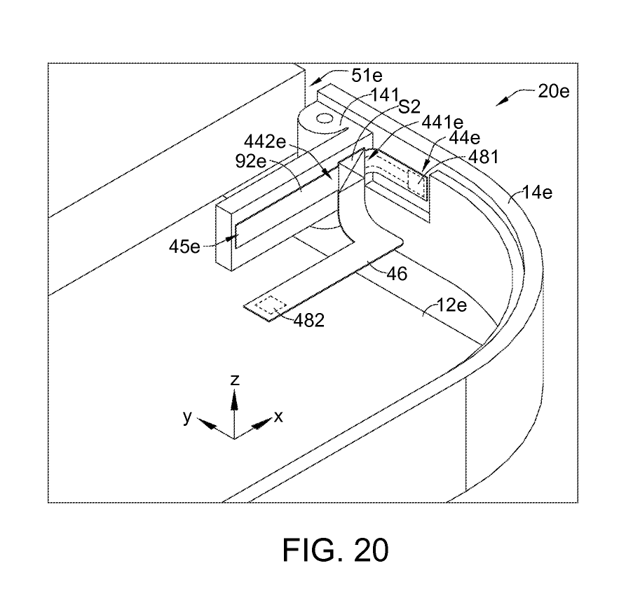

By controlling on and off of the switches S1 and S2, the antenna 20e (FIGS. 10) and 20f (FIG. 15) are capable of providing a variety of low-bands, so as to adapt various band requirements. The switch S1 in FIG. 10 or FIG. 15 may be implemented by the circuit board 12e (FIG. 10) or 12f (FIG. 15), so the switch S1 can be electrically controlled. The switch S2 in FIG. 10 or FIG. 15 may also be implemented by the circuit board 12e (FIG. 10) or 12f (FIG. 15). Alternatively, the switch S2 may also be implemented by an additional flexible circuit board. For example, along with FIG. 10, please refer to FIG. 20 illustrating an embodiment to implement the switch S2 of the antenna 20e in FIG. 10. As shown in FIG. 20, the switch S2 may be formed by a flexible circuit board 46, which may also include a pad 481, the conductive section 92e and a pad 482. The pad 481 may be conductively attached to the metal part 14e at the position 44e, and may be connected to a first terminal of the switch S2 at the position 441e of the flexible circuit board 46. The section 92e may extend from a second terminal of the switch S2 (at the position 442e of the flexible circuit board 46) to the position 45e of the flexible circuit board 46. The pad 482 may be conductively attached to the circuit board 12e for receiving a control signal (not shown) issued from the circuit board 12e; according to the control signal, the switch S2 can turn on and off to selectively conduct between its first and second terminals at positions 441e and 442e. The flexible circuit board 46 may be supported by a dielectric interior structure 141 which may isolate the flexible circuit board 46 from the metal part 14e except at the pad 481. Likewise, the switch S2 of the antenna 20f (FIG. 15) may be arranged in a manner similar to FIG. 20. Any of he feed strips 30a to 30f respectively shown in FIG. 1, FIG. 6, FIG. 7, FIG. 9, FIG. 10 and FIG. 15 may also be formed by a flexible circuit board.

In the embodiment of FIG. 10, though the additional strip 70e linearly extends along y-direction, the strip 70e may also combine x-directional segment(s), y-directional segment(s), tilt segment(s) and/or curved segment(s) to extend from the position 701e to the position 702e. Similarly, the strip 70f in the embodiment of FIG. 15 does not have to be shaped along a straight line from the position 701f to the position 702f.

Similar to the embodiments shown in FIG. 6 and FIG. 9, the antennas 20e and 20f in FIGS. 10 and 15 may also include auxiliary strip(s) to tune antenna characteristics and performance.

To sum up, rather than feeding a grounded arm by physical contact, antenna according to the invention feeds the ground component by noncontact couple feed, so as to effectively avoid mechanical robustness issues of conductive contact, enhance reliability and durability, and maintain proper operation of antenna.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An antenna for a device, comprising:
a feed strip having a feed port for relaying a feed signal, and
a ground component for connecting a ground voltage;
wherein the feed strip does not physically contact the ground component, and a first portion of the ground component comprises at least a portion of a metal part along a surface of the device.

2. The antenna of claim 1, wherein the ground component further comprises an inner portion extending to a contact of the metal part, and the first portion is a segment of the metal part extending from the contact and ending at a gap of the metal part.

3. The antenna of claim 2, wherein the gap is adjacent to an opening of the device.

4. The antenna of claim 2, wherein a part of the inner portion is formed by a ground plane of a circuit board of the device.

5. The antenna of claim 4, wherein the feed strip is formed by a conductive layer of the circuit board, and the conductive layer is insulated from the ground plane.

6. The antenna of claim 2, wherein the inner portion is formed by a ground plane of a circuit board of the device and a conductive wall extending from the ground plane to an opening of the device.

7. The antenna of claim 6, wherein the feed strip is formed by a conductive layer of the circuit board, and the conductive layer is insulated from the ground plane.

8. The antenna of claim 1, wherein the ground component further comprises a tuning strip extending from an end of the first portion toward interior of the device.

9. The antenna of claim 1, wherein the feed strip comprises: a trunk and a first branch; the trunk extends from the feed port to a trunk end along a first direction, and the first branch extends from the trunk end along a second direction.

10. The antenna of claim 9 further comprises:
a first quantity of first auxiliary strips, each first auxiliary strip having an auxiliary ground terminal for connecting the ground voltage, each first auxiliary strip having no physical contact with the feed strip, and comprising a division extending along an offset contour of the trunk and the first branch.

11. The antenna of claim 9, wherein the feed strip further comprises a second branch extending from the trunk end along a third direction.

12. The antenna of claim 11, wherein the second direction and the third direction are parallel.

13. The antenna of claim 11 further comprises:
a second quantity of second auxiliary strips, each second auxiliary strip having an auxiliary ground terminal for connecting the ground voltage, each second auxiliary strip having no physical contact with the feed strip, and comprising a division extending along an offset contour of the trunk and the second branch.

14. The antenna of claim 9, wherein the first direction is perpendicular to the second direction.

15. The antenna of claim 1 further comprises:
a quantity of auxiliary strips, each auxiliary strip having an auxiliary ground terminal for connecting the ground voltage, each auxiliary strip having no physical contact with the feed strip, and extending without intersecting the ground component.

16. The antenna of claim 15, wherein each auxiliary strip extends along an offset contour of the feed strip.

17. The antenna of claim 1 further comprising:
a switch connected to the first portion, and the ground component further comprising:
a tuning strip extending from the switch toward interior of the device;
wherein the switch is capable of selectively conducting between the first portion and the tuning strip.

18. The antenna of claim 1 further comprising:
a first switch connected to a first node of the ground component, and
an additional strip connected between the first switch and a second node of the ground component;
wherein the first switch is capable of selectively conducting between the additional strip and the first node.

19. The antenna of claim 18, wherein the ground component further comprises:
a second switch separating the ground component into a tail section and a head section, and capable of selectively conducting between the tail section and the head section.

20. The antenna of claim 19, wherein the first node and the second node are at the head section.
